(19) United States
(12) Patent Application Publication
(10) Pub. No.: US 2015/0046875 A1
(43) Pub. Date: Feb. 12, 2015

(54) HIGH-EFFICACY CAPTURING AND MODELING OF HUMAN PERCEPTUAL SIMILARITY OPINIONS

(71) Applicant: UT-Battelle, LLC, Oak Ridge, TN (US)

(72) Inventors: Songhua Xu, Oak Ridge, TN (US); Georgia Tourassi, Oak Ridge, TN (US)

(73) Assignee: UT-Battelle, LLC, Oak Ridge, TN (US)

(21) Appl. No.: 13/961,400

(22) Filed: Aug. 7, 2013

(51) Int. Cl. G06F 3/0484; G06F 3/0481; G06F 3/0482

(52) U.S. Cl. CPC G06F 3/04842; G06F 3/0482; G06F 3/04817
USPC 715/834

(57) ABSTRACT

A personalized human perceptual opinion capturing and modeling system includes a processor and memory. Logic stored in the memory renders a user interface on an electronic display. The user interface includes many active areas radially linking multiple peripheral image objects to a central image object where an image object is an object of an image or a visually represented entity. The multiple peripheral image objects are positioned around a curved path about the central image object. The active areas include impression characteristic objects associated with hyperlinks that render a second user interface. The second user interface displays a selected peripheral image object, the central image object, and a color mapping model or a visual feedback mechanism. A database stores user expressed perceptual opinion data representing the similarity of the selected peripheral image object to the central image object. A user's positional movements of a positional object rendered on the electronic display enable the user to visually express and represent the similarities between each of the plurality of peripheral image objects to the central image object through the impression characteristic objects, a visual heuristic object, and a spatial separation.

### 1. STATEMENT REGARDING FEDERALLY SPONSORED RESEARCH AND DEVELOPMENT

The inventions were made with United States government support under Contract No. DE-AC05-000R22725 awarded by the United States Department of Energy. The United States government has certain rights in the inventions.

### BACKGROUND

1. Technical Field

This disclosure relates to interfaces and more particularly to a graphical user interface that captures individual human subjects' personal opinions on the perceptual similarities of visual images or visually represented objects.

2. Related Art

Content-based image retrieval (CBIR) is often based on people's opinions about visual similarities. CBIR technology directed to human users may render quantitative or qualitative metrics that reflect perceptual opinions. The development and proper validation of such metrics depend on the number and diversity of images presented to users during a data collection process.

Some CBIR systems ignore perceptive subjectivity and embrace universal rather than personalized modeling approaches. These CBIR systems focus on deriving image similarity metrics that measure opinions of many users about the visual similarity of a pair of images. One such metric is a rating in which users apply a score to record their opinions regarding pairwise image similarities. Some systems use absolute scores or discrete scores on a fixed point scale. While such discrete ratings provide a uniform quantitative output, the ratings ignore user inconsistencies in applying numerical scores to rate multiple image pairs, personal biases due to internal cognitive processes, and biases inherent in individual personality traits.

Some CBIR systems rely on questionnaires. These systems evaluate visual similarities through questions. Such systems are not effective in the visual domain because it is difficult and unnatural for a typical human user to express opinions either verbally or numerically. Some users rely on intuitions or their semi-conscious recognition of visual artifacts to assess pairwise image perceptual similarities.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1 is a graphical user interface that captures and models human perceptual opinions.

FIG. 2 is a second graphical user interface that captures and models human perceptual opinions.

FIG. 3 is a graphical user interface of an image rating system.

FIG. 4 is a third graphical user interface that captures and models human perceptual opinions.

### BRIEF DESCRIPTION OF THE APPENDIX

The Appendix that is part of this disclosure provides a comparative analysis of data collection methods for individualized capturing and modeling of radiologists' visual similarity judgments in mammograms using an embodiment described in the Detailed Description of the Preferred Embodiments.

### DETAILED DESCRIPTION OF THE PREFERRED EMBODIMENTS

An automated perceptual opinion capturing and modeling system streamlines data collection by coordinating many dimensions in a semantic context. The system enhances data collection by gathering opinions directly from users in real-time, near real-time, or with a delay at a physical or a virtual site. The system may leverage data by allowing users to qualitatively rank peripheral image objects in a common graphical interface window or on an electronic screen on a local client. The window may be divided into several graphical interface windows in a windowing environment, each of which may contain a different image or in alternative systems another view of the same image.

Some systems allow a user to select or enter details about selected peripheral image objects and in some systems qualitatively or quantitatively and visually link the degree of visual similarity (e.g., objective or subjective visual similarity) between peripheral image objects and a central image object in one, two, or more measures or dimensions. The differences in the images may be represented and intuitively indicated through visually discernible spatial separations and/or impression characteristic objects that are associated with the peripheral image objects. The spatial separations and/or impression characteristic objects may be rendered on a visual screen, portion of a visual screen, or through a graphical user interface window rendered on a visual screen or electronic display. The impression characteristic and peripheral image objects may be associated with or hyperlinked to pages or views that serve a selected peripheral image object, a central image object, and a color mapping model that may allow users to visually express and represent the degree of similarity between the selected peripheral image object and the central image object through a color mapping model such as a Red, Green, and Blue (RGB) color mapping model, for example.

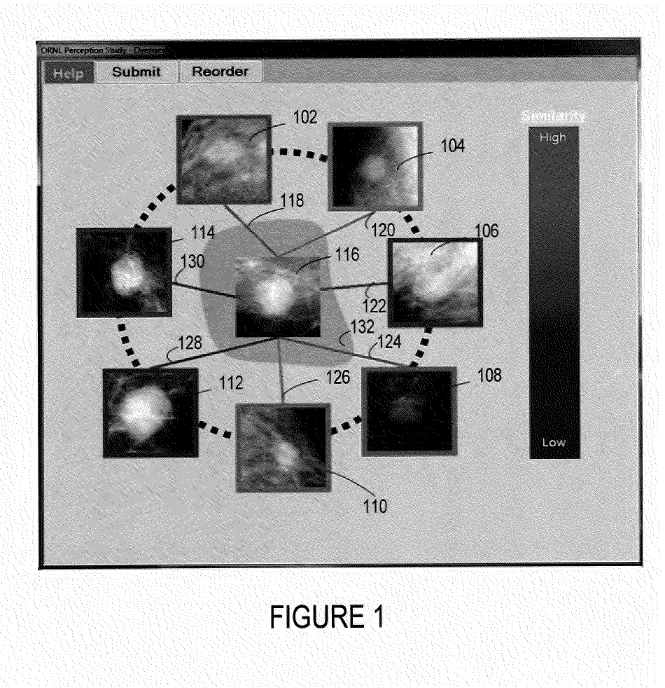

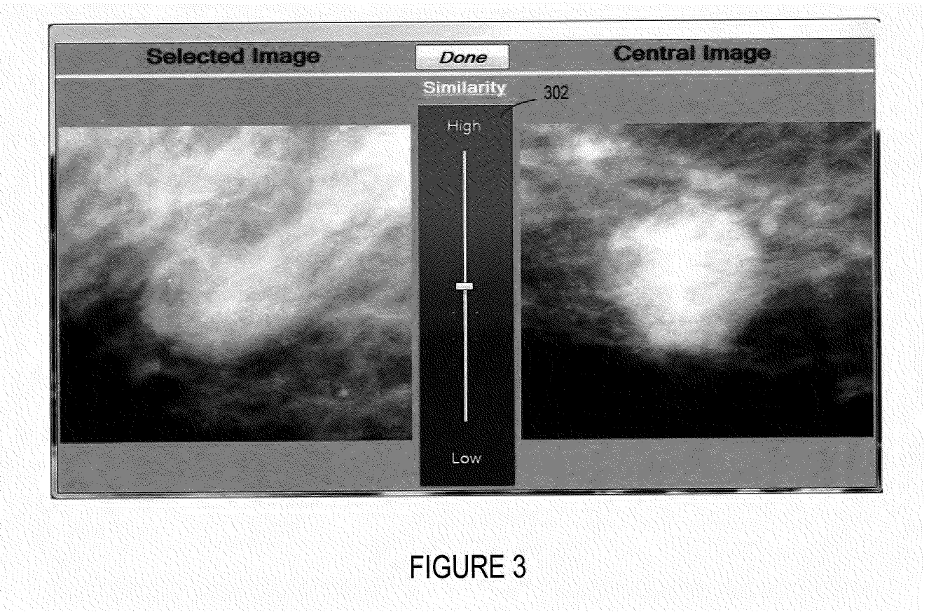

The automated human perceptual opinion capturing and modeling system may transform data into visual objects so that it provides useful content that may be used or supplemented while reducing the amount of data entries and processing required by the self-servicing perceptual opinion capturing and modeling system. As shown in FIG. 1, peripheral image objects 102-114 are graphically positioned about a curved path such as an orbit revolving around a central image object 116. The peripheral image objects 102-114 are radially coupled to the central image object 116 by an impression characteristic object (shown as colored lines) hyperlinked to one or more pages or views showing greater details about a selected peripheral image object and the central image object 116. The selected peripheral image object and the central image object 116 may be displayed in a zoomed-in view with the accompany of a color mapping model 302 that a user may apply to represent the degree of similarity (or in alternative systems differences) between a selected peripheral image object and the central image object 116 as shown on the Web page in FIG. 3. In FIG. 3, the color palette of the color mapping model 302 may be associated with quantitative values, numerical opinions, and/or descriptive scales that represent the opinions of the user. In other words, a designated color may represent a user's subjective rating of the similarity between the peripheral image objects 102-114 and the central image object 116 in FIG. 1.

In FIG. 1, the various and differing color radial lines 118-130 linking the peripheral image objects 102-114 to the central image object 116 and the colored boundaries that frame and/or bound the peripheral image objects 102-114 comprise the impression characteristic objects. In some perceptual modeling systems, the color coding of the radial lines 118-130 and boundaries that frame the peripheral image objects 102-114 represent the user's subjective, perceptual opinions of the degree of similarity between the peripheral image objects 102-114 and the central image object 116. In other systems, the radial line and/or boundary patterns, shapes, line widths, colorfulness, chroma, saturation, tint, shade, etc. and/or combinations are used to visually represent the user's opinions of the similarities (or in alternative systems differences) between the peripheral image objects 102-114 and the central image object 116 or may represent a finer, more detailed rating of the peripheral image objects 102-114 to the central image object 116.

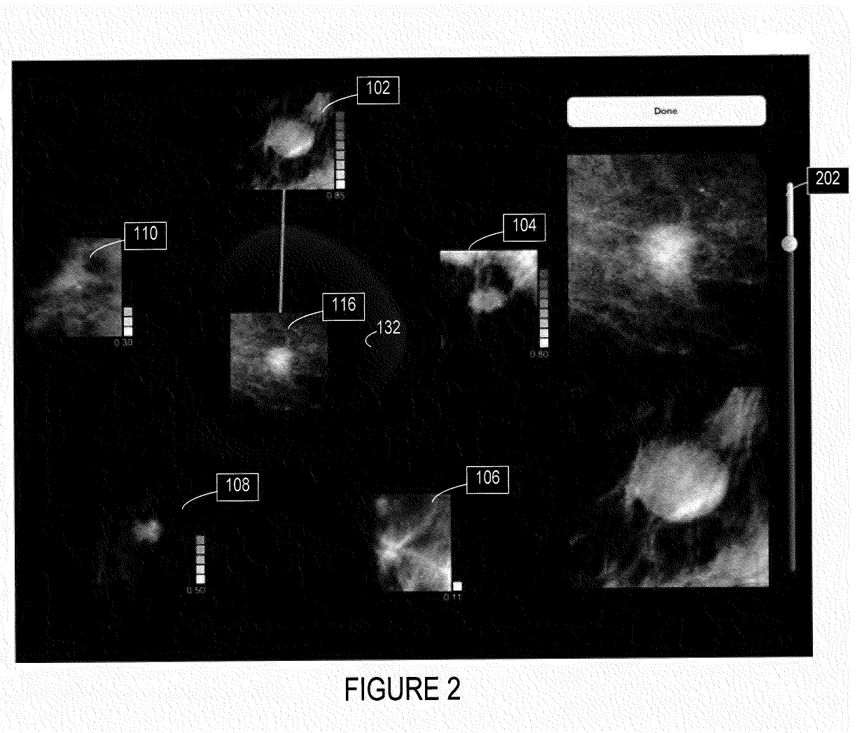

Some perceptual opinion capturing and modeling systems include a visual heuristic object 132 that underlays and surrounds the central image object 116 as shown in FIGS. 1 and 2. The visual heuristic object 132 shown in FIG. 1 intersects a portion of the impression characteristic objects (e.g., each of the radial lines 118-130) linking each of the peripheral image objects 102-114 to the central image object 116. Through a non-rigorous self-learning code, the shape and/or contour of the visual heuristic object 132 automatically changes so that the visual heuristic object 132's curved or bounded region is closer to the peripheral image objects 102-114 when its corresponding or adjacent peripheral image object more closely resembles the central image object 116 as perceived by the end human subject. As a peripheral image object is designated more different and distinct under a user's perceptual opinion, the separation between visual heuristic object 132 and that selected peripheral image object increases. As a selected peripheral image object is designated more similar and alike by a user, the spatial separation between that visual heuristic object 132 and the selected peripheral image object decreases. In some perceptual modeling systems, the spatial separation between the intersection points between the radial lines linking the peripheral image objects 102-114 to the central image object 116 (a portion of the impression characteristic objects) and the visual heuristic object 132 may increase as peripheral image objects 102-114 are judged to be more different than central image object 116; and may decrease when peripheral image objects 102-114 are perceptually judged to be more similar to the central image object 116. In some systems spatial separation may reflect the degree of similarities (or in alternative systems differences) between each respective peripheral image object and the central image object 116 it is linked to. The spatial separation may comprise a rating scale that measures the degree of similarities (or differences in alternative systems). Subjective qualitative and quantitative assessments of similarity (or in alternative systems differences) are made on predetermined metrics, measures, or dimensions for establishing where peripheral image objects 102-114 fall on a continuum of similarity (or in alternative systems differences). Unlike numerical scales or descriptive scales, the visual heuristic object 132 comprises a graduated visual scale rendered by changing the shape of the heuristic object 132 and the appearance (e.g., color) of the impression characteristic objects. The visual scale may be automatically translated into or supplemented by numerical scales and/or descriptive scales by the perceptual capturing and modeling system.

To rate a selected peripheral image object against the central image object 116, a user may select an active area associated with the selected peripheral image object that may be served through a Web page or a screen view. Selection of an active area directly associated with the selected peripheral image object may render multiple color mapping models adjacent to each of the peripheral image objects 102-114 on a Web page or a screen view as shown in FIG. 2. Selection of an active area may also render magnified views of the peripheral image object to be rated and the central image object 116 on the Web page or a screen view as further shown in FIGS. 2 and 3. A zoom object shown as a slider 202 or track bar is also rendered on the Web page or the screen view. In FIG. 2, the slider 202 shown adjacent to an enlarged view of a selected peripheral image object and the central image object 116 allows a user to enlarge or magnify the selected peripheral image object and the central image object 116. Settings may be adjusted by moving the indicator in a vertical or horizontal fashion or by clicking or pointing to active areas, the user operation of which triggers automatic adjustment of the settings.

In alternative perceptual opinion capturing and modeling systems, selecting an active area associated with a selected peripheral image object, such as active areas associated with the impression characteristic objects (e.g., one of the radial lines) may activate a hyperlink to Web pages or screen views that serve the selected peripheral image object, the central image object 116, and a color mapping model 302. The color mapping model 302 may include a legend associated with a continuum of color with the hue reflecting a rating representing degree of similarity between the selected peripheral image object and the central image object 116 as shown in FIG. 3.

In FIG. 3, the RGB color mapping model includes a scroll-bar or a slider that may be enabled through a user's absolute and/or relative pointing device or through the user's physical gesture such as a hand gesture or verbal commands. In some perceptual opinion capturing and modeling systems the distal and proximal ends of the slider 302 may represent the highest and lowest degrees of similarity scores the system allows. An intermediate position may represent a neutral opinion. In some perceptual opinion capturing and modeling systems active areas and objects positioned at the ends of the slider bar 302 enable the user to move a scroll box or positional object in predetermined increments, to move to an arbitrary location, or travel in larger or smaller predetermined increments across the visual scale. By the positional movement of the scroll box or positional object, a user may establish and record his or her opinion about the similarities between the selected peripheral image object and the central image object 116.

Based on the user's input, the similarities between a selected peripheral image object and the central image object 116 are recorded and stored, and the perceptual opinion capturing and modeling system modifies the impression characteristic objects associated with the selected peripheral image object and the visual heuristic object 132 that underlays and surrounds the central image object 116. For example, the radial lines and boundaries that are associated with the peripheral image objects 102-114 may match the user's visual rating (e.g., color selected), and the spatial separation between the visual heuristic object 132 and the selected peripheral image object automatically changes to reflect the new visual ratings. The spatial separation may reflect the ranking position of the evaluated peripheral image object relative to the prior visual ratings a user previously assigned (or default ratings if not yet assigned) to the remaining peripheral image objects.

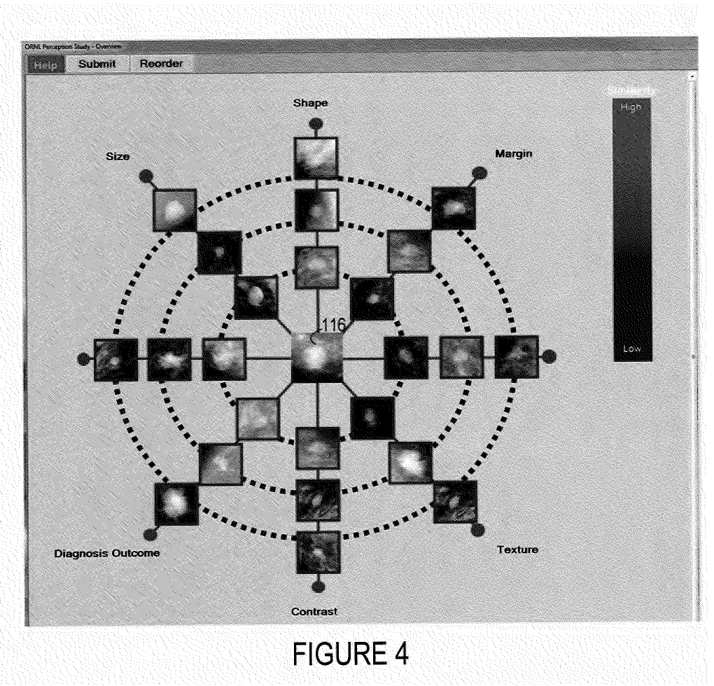

An alternative perceptual modeling system may render additional peripheral image objects positioned on different radial orbits such as those shown revolving about the central image object 116 in FIG. 4. The peripheral image objects are radially separated on distinct metrics, measures and/or dimensions illustrated by each radial line. In a medical context, the dimensions may comprise any measurable attribute such as contrast, texture, diagnosis outcome, or other semantics, for example. The graphical user interface shown on the Web page in FIG. 4 visually informs the users of their ratings in the context of each of these evaluated dimensions. The peripheral image object closest to the central image object 116 may reflect the highest similarity in that metric, measure, or dimension and the peripheral image objects positioned on the outer orbits reflect more differences between other peripheral image objects and the central image object 116. The further peripheral image objects are from the central image object 116 (or those on the larger orbits) the greater the difference in that metric, measure, or dimension designated to that radius. As shown, the peripheral image objects may also include one or more of the impression characteristic objects. And, each of the peripheral image objects may be associated with the active area served through a Web page or a screen view (such as those illustrated in FIG. 2) and/or the hyperlinks served through Web pages or screen views (such as those illustrated in FIG. 3).

Some alternative perceptual opinion capturing and modeling systems such as the system shown in FIG. 4 may also include a dedicated or aggregated dimension rendered on a separate radial line or lines. The aggregated dimension automatically re-positions each of the peripheral image objects rendered on the aggregated radial line(s) through an aggregation or combination of all the ratings of a peripheral image object in each dimension. The synthesized or aggregated rating represents an overall rating of the peripheral image object relative to the other peripheral image objects on the same graphical interface. The rating aggregates some or all of the different dimensions.

The perceptual opinion capturing and modeling systems may be served on a local area and/or wide area network that splits processing of an application between a front-end client and a back-end server or server cluster that may be part of a client-server architecture. The client may comprise a local or remote computer or controller that may execute specific computer applications to send data over a network or pull content from a Web site. A customized client-server protocol may be used to communicate between a privately accessible network and a publicly accessible network. The server or host server may comprise a single computer or a group of independent network servers that operate, and appear to local or remote clients, as if they were a single unit although they may be spread across a distributed network. The server may comprise hardware that may communicate with back-end processors that execute programs that provide time sharing and data management between local or remote clients, provides multi-user functionality, supports persistent and/or non-persistent connections with local or remote clients, and/or may provide or stand behind various firewalls and other security features. The logic and programming may be distributed among multiple memories that preserve data for retrieval and may provide access or support other devices, some of which may work independently but also may communicate with other remote or local devices that have similar or different operating systems.

Some perceptual opinion capturing and modeling systems include interfaces or back-end processors that execute software that quantifies data. Perceptual opinions or selected impression characteristic objects may be quantified (e.g., in some cases, priorities may be translated into numerical values or priority indicia that may be based on a numerical point scale) to evaluate visual images or visually represented objects.

The perceptual opinion capturing and modeling systems may be served or executed via multiple remote or local clients supporting Web browsers and/or graphical user interfaces in some systems. Information may be encrypted, using digital signatures, or may be processed or supplemented with other security measures to protect the integrity of the information. Remote clients may be coupled to the system through a matrix of networks, gateways, bridges, routers, and/or other intermediary devices that handle data transfer and/or data conversions from a sending network protocol to a similar or different receiving network protocol. Intraware, groupware, or other software executed by a processor may translate the data received from the clients, remote computers, into the data that is received and stored on a host server through a publicly accessible distributed network like the Internet or a privately accessible network like an Intranet. The data may include text, graphics, images, and/or other information that may be stored at substantially the same rate as the data is received, after some delay, at a near real time rate or in real time in memory resident to or coupled to the host server. A real-time operation may comprise an operation matching a human's perception of time or a virtual process that is processed at the same rate (or perceived to be at the same rate) as a physical or an external process. The data may be received through communication with distributed or central commercial or governmental servers. The commercial or governmental servers may serve specific or unique data about a user. The data may be processed by a server, server cluster, processor, or client of perceptual opinion capturing and modeling systems to ensure that rating processes are in compliance with a study's requirements.

Some perceptual opinion capturing and modeling systems communicate with a server cluster linked to a data warehouse (e.g., one or more databases that may be distributed and accessible to many computers and may retain information from one or many sources in a common or variety of formats), and in some alternative systems, linked to external content servers and legacy systems. The server clusters provide functionalities that allow users to rate visual images or visually represented objects through a self-servicing communication channel. The server cluster may support a thin client (or thin server) architecture. Extensible rating rules and a user perceptual opinion expression layer may customize the features and software that may be transferred to a remote client computer. The server cluster may process or serve the tasks associated with applying, qualifying, and/or evaluating images. In some perceptual opinion capturing and modeling systems, the server cluster executes software that automatically renders the dynamic, fixed, and/or variable content that may be delivered directly to a user or indirectly through an intermediary.

The details of a user perceptual opinion expression session may be stored in one or more files that comprise records. The records may contain fields, together with a set of operations that facilitate searching, sorting, recombining, and other functions. The data warehouse may comprise one or more databases (e.g., Structured Query Language databases or SQL DBs, databases that comprise one or more flat files, such as 2-dimensional arrays, etc.) that retain the information needed to qualify, validate, and record perceptual opinions expressed by an end user. While the data warehouse may be distributed across remote locations, accessed by several computers, and may contain information from multiple sources in a variety of formats, some data warehouses are directly accessible to or resident to the server cluster. For longer-term storage or data analysis, data may be retained in archival database(s). Some systems include a back-up that allows the data warehouse to be restored to a user perceptual opinion expression session when enabled. The system may restore the data warehouse automatically when a software or hardware error has rendered some or the entire data warehouse unusable. When a more serious error occurs, the backup data warehouse may automatically step in and assume the processes and functionality served by the data warehouse when the server cluster or a monitoring system identifies software or hardware errors that have rendered a portion of the database, or the entire database, unusable. In some circumstances, that original data warehouse or a replacement may serve as a storage back-up when the errors are corrected.

The databases may comprise hierarchical databases that retain searchable indices within the database that reference distinct portions of the database and/or data locations within ancillary storage devices or remote databases. The databases and storage devices may be accessible through a file server and/or a database management server. Data warehouse access may be transparent to the user, who may use commands to retrieve and receive all or selected information. The data warehouse may contain data about how the warehouse is organized, where the information may be found, and how the data may be related.

A server cluster may also communicate with legacy systems and/or backend systems that may reside behind firewalls that protect the server clusters and the data warehouse. Compatibility with the legacy systems and/or backend systems may be managed by the server cluster or by separate interfaces (e.g., remote), integrated, or programmed within the legacy systems and/or backend systems.

In some perceptual opinion capturing and modeling systems, the client (e.g., remote client) is run within a sandbox. The sandbox may comprise a closely-controlled remote environment that may have limited access to client resources. A Javascript may interface the client to provide some access to local and/or remote resources. In alternative applications, the client may rely on a certificate approach (e.g., ActiveX controls) that is not limited by sandbox restrictions. A certificate approach may be used by Java and Javascript programs and controllers.

When rendered on a portable device such as a tablet like an Apple iPad™, the code that renders the perceptual opinion capturing and modeling system, such as a Broadcast Markup Language or BML may be transformed into HTML code that may be rendered on a mobile device through a mobile translator architecture. The translator may modify the code that renders Web pages or screen views that generate the human perceptual opinion capturing and modeling system that is compatible with the screen size and architecture of the mobile device executing the perceptual opinion capturing and modeling system, such as what script or version a mobile device may or may not be supporting. The mobile translator may transmit only the code that complies with the user's mobile device architectural specification. The more advanced the mobile device may be, the more features or rich features may be transmitted by the mobile translator architecture that may enable many touch-points to the perceptual opinion capturing and modeling system.

The methods, devices, systems, and logics described above may be implemented in many other ways in many different combinations of hardware, software or both hardware and software and may be used to compare, contrast, and visually rate many objects from medical images (e.g., mammography images) to products (e.g., jewelry and clothing). All or parts of the system may detect and compare images, which may be executed through one or more controllers, one or more microprocessors or central processing units (CPUs), one or more signal processing units (SPU), one or more graphics processing units (GPUs), one or more application specific integrated circuits (ASIC), one or more programmable media or any and all combinations of such hardware. All or part(s) of the logics described above may be implemented as instructions for execution by many processors (e.g., CPUs, SPUs, and/or GPUs), controllers, or other processing devices and may be displayed through a display driver in communication with a remote or local display, or stored in a tangible or non-transitory machine-readable or computer-readable medium such as flash memory, random access memory (RAM) or read only memory (ROM), erasable programmable read only memory (EPROM) or other machine-readable medium such as a compact disc read only memory (CDROM), or magnetic or optical disk. Thus, a product, such as a computer program product, may include a storage medium and computer readable instructions stored on the medium, which when executed, cause the device to perform the specially programmed operations according to any of the descriptions above.

The perceptual opinion capturing and modeling systems may evaluate images shared and/or distributed among multiple users and system components, such as among multiple processors and memories (e.g., non-transient media), including multiple distributed processing systems. Parameters, databases, comparison software, pre-generated models and data structures used to evaluate and analyze or pre-process the high and/or low resolution images may be separately stored and managed, may be incorporated into a single memory block or database, may be logically and/or physically organized in many different ways, and may be implemented in many ways, including data structures such as linked lists, hash tables, or implicit storage mechanisms. Programs may be parts (e.g., subroutines) of a single program, separate programs, application program or programs distributed across several memories and processor cores and/or processing to nodes, or implemented in many different ways, such as in a library or a shared library accessed through a client-server architecture across a private network or public network like the Internet. The library may store software codes of detection and classification models that perform any of the system processing described herein. While various embodiments have been described, it will be apparent to those of ordinary skill in the art that many more embodiments and implementations are possible.

The term “coupled” disclosed in this description may encompass both direct and indirect coupling. Thus, first and second parts are said to be coupled together when they directly contact one another, as well as when the first part couples to an intermediate part which couples either directly or via one or more additional intermediate parts to the second part. The term “substantially” or “about” may encompass a range that is largely, but not necessarily wholly, that which is specified. It encompasses all but a significant amount. When devices are responsive to command events, and/or requests, the actions and/or steps of the devices, such as the operations that devices are performing, necessarily occur as a direct or indirect result of the preceding commands, events, actions, and/or requests. In other words, the operations occur as a result of the preceding operations. A device that is responsive to another requires more than an action (i.e., the device's response to) merely following another action.

While various embodiments of the invention have been described, it will be apparent to those of ordinary skill in the art that many more embodiments and implementations are possible within the scope of the invention. Accordingly, the invention is not to be restricted except in light of the attached claims and their equivalents.

### APPENDIX

### Comparative Analysis of Data Collection Methods for Individualized Modeling of Radiologists' Visual Similarity Judgments in Mammograms

### Rationale and Objectives:

An observer study investigated how the data collection method affects the efficacy of modeling individual radiologists' judgments regarding the perceptual similarity of breast masses on mammograms.

### Materials and Methods:

Six observers of variable experience levels in breast imaging were recruited to assess the perceptual similarity of mammographic masses. The observers' subjective judgments were collected using: (i) a rating method, (ii) a preference method, and (iii) a hybrid method combining rating and ranking. Personalized user models were developed with the collected data to predict observers' opinions. The relative efficacy of each data collection method was assessed based on the classification accuracy of the resulting user models.

### Results:

The average accuracy of the user models derived from data collected with the hybrid method was 55.5%±1.5%. The models were significantly more accurate (P-value <0.0005) than those derived from the rating (45.3%±3.5%) and the preference (40.8%±5%) methods.

### Conclusions:

A hybrid method combining rating and ranking is an intuitive and efficient way for collecting subjective similarity judgments to model human perceptual opinions with a higher accuracy than other more commonly used data collection methods.

### Introduction:

This study brings attention to an issue mostly ignored in perceptual similarity studies—namely, the effect of the data collection method in deriving accurate and reliable user models for predicting individual opinions. Understanding whether the data collection method impacts individualized modeling of radiologists' opinions regarding image similarity is an important step for building more effective CBIR systems. This study offers a systematic comparison among three methods: (i) a rating method (ii) a preference method, and (iii) a hybrid method that combines the strengths of the preference and rating methods. The comparison is based on the predictive accuracy of personalized user models derived with data collected using each method respectively. The overarching goal is to determine which data collection method facilitates the development of user models that can reliably capture subjective visual similarity across radiologists with different experience levels. Experiments were conducted for the visual task of similarity assessment of breast masses on mammograms.

### Materials and Methods

### Image Database

Regions of interest (ROIs), 2.6 cm by 2.6 cm in size, containing biopsy-proven masses were obtained from the Lumisys volumes of the Digital Database of Screening Mammography (DDSM). ROIs that (i) did not fully include the mass, (ii) were considered of poor image quality, and (iii) included calcifications that may influence radiologists' judgments were excluded from the study. Architectural distortions and focal asymmetries were also excluded. Forty ROIs depicting distinct mammographic masses of approximately similar size were randomly selected. The depicted masses represented the full range of shapes and margins according to the BI-RADS descriptors provided in DDSM. Of the 40 ROIs, 13 were extracted from LCC views, 10 from LMLO views, 8 from RCC views, and 9 from RMLO views. The final set included 26 malignant masses and 14 benign masses, shown in FIG. 1A.

### Data Collection Method

Collection of observer data was done using three different study protocols. For each protocol, a different graphical user interface (GUI) was developed as an iPad application. The design of a user-friendly, intuitive GUI on the iPad platform is essential for ensuring smooth operation without any unnecessary delays throughout the course of the study. The following is a detailed description of each data collection protocol and the GUI implemented for the corresponding study protocol.

Rating Method:

The study participant is presented with a pair of masses, as shown in FIG. 2A. The participant is asked to provide a similarity score for the pair using a continuous scoring scale from 0 (=highly dissimilar) to 1 (=highly similar). As mentioned earlier, this data collection method is the one used most often in Radiology for human perception similarity and CBIR studies.

Preference Method:

In this method, the study participant is presented with a triplet of masses (A,B,C), as shown in FIG. 3A, and asked to identify the pair with the highest visual similarity. In contrast to the rating method, no numerical score is asked explicitly. Instead, the participant must make one of four possible choices; namely, select one of the three possible pairs of masses (A and B, A and C, B and C) that appear visually most similar or report that no particular pair stands out as being most similar than the rest.

In general, the preference method presents an easier task to the study participants than the rating method, but that conclusion depends on the relative differences between the pairs. For example, intra-observer variability is unavoidable if the radiologist is asked to rank pairs of masses with similar BI-RADS characteristics. One of the drawbacks of the preference method is the lack of absolute quantitative information regarding the similarity of two images, since it only collects relative information with respect to other image pairs.

Hybrid Method:

The third data collection method builds upon the strengths of the other two. The radiologist is presented with a query mass at the center of the program window and other masses presented in a circular format around the query (FIG. 4A). The participant is asked to assign a rating score to each peripheral mass based on its similarity to the central/query mass. The participant can adjust the rating scores of the peripheral masses while refining his judgment regarding the relative ranking of all possible pairs (i.e., those created by pairing the query mass with each one of the peripheral masses individually).

For the present study, the GUI was implemented to display 5 peripheral masses at one time. It was also designed in a user-friendly way to meet the anticipated expectations of all potential users. As the GUI user assigns a rating score to a peripheral mass, the corresponding corner point of the peripheral mass automatically changes its axial distance to the central position of the query image while keeping its axial angle. That is, the corner point has one degree of freedom, which is along its axial direction from the center of the query image. The corner point stays the closest to the central position if the assigned rating score reaches the maximum value of 1. As it can be seen in FIG. 4A, the GUI displays a deep blue circular area surrounding the central image where the circle's boundary indicates all potential positions for a corner point that corresponds to the maximum rated score of 1. Under the opposite condition, when the user rating receives the minimum value of 0, this corner point deviates the farthest away from the central position, also along the axial direction. Therefore, according to the positions of the corresponding corner points of all peripheral masses, a polygonal region with rounded corners is generated and updated in real time. Such region-based spatial presentation provides an intuitive way to visually communicate to the user: 1) his/her perceptual rating of the visual similarity between each peripheral image and the central query image, and 2) his/her preference ranking regarding the relative perceptual similarities of the peripheral images with respect to the query image.

In addition, since the iPad screen limits the size of the displayed masses (due to the fact that 6 masses are displayed concurrently), the user may manipulate the interface by tapping on the connecting line between one peripheral mass and the query mass for a zoomed-in view. Zooming capability was available with the other GUIs as well. One advantage of the hybrid data collection method is that it generates a rich dataset with both rating and ranking opinions. Furthermore, the ranking feedback may help the user be more self-consistent when assigning pairwise numerical rating scores by offering more visual context.

### Observer Study

Institutional review board approval was obtained prior to the study. Six observers of variable experience levels were recruited for this study to provide their perceptual opinions regarding pairwise mass similarities using the three GUIs respectively. Informed consent was obtained from all radiologists. The group included 2 MQSA-certified expert breast imagers each with more than 15 years of clinical practice, 2 Radiology residents with more than four mammography rotations, and 2 Radiology residents with only one mammography rotation at the time when the study was conducted.

The study conducted the observer study using two iPads 2 (Apple Inc, Cupertino, Calif.) with 9.7-inch diagonal LED backlit, glossy widescreen, multi-touch display, 1024×768 resolution, and equal maximum, minimum, and 50% gray-level luminance. The mass ROIs selected for the observer study were displayed “as-is” without any additional image processing. Furthermore, the observers were not allowed any window-leveling manipulation during the data collection process. For the rating method, the observers were presented with 100 distinct pairs of masses for evaluation. The pairs were created by sampling randomly from the 40 available masses. During presentation the study ensured that none of the two masses composing a given pair appeared in the five immediately following pairs. For the preference method, the observers were presented with 100 distinct mass triplets. Random selection and similar presentation restriction were also applied. Finally, for the hybrid method, the observers were presented with 20 query masses. This presentation setup translates to 100 pairwise rating evaluations (20 queries×5 peripheral masses). Therefore, the observers evaluated 100 “cases” under each data collection method, where the term “case” implies a mass pair or triplet, depending on the collection protocol as discussed earlier.

Prior to the study, all observers participated in a training session to familiarize themselves with the three GUIs. Upon training, the observers were presented with the full collection of the 40 masses (as shown in FIG. 1A). They were allowed as much time as needed to review the masses, assess the difficulty range of the mass similarity assessment task, and possibly form an internal calibration scheme for performing the task with self-consistency. The observers were given clear instructions on what is expected of them but not any definition regarding visual similarity. In other words, they were left open to impose their own definition or interpretation regarding perceptual similarity as well as choosing how to weigh the various image aspects that could influence their similarity opinions. Then, all observers executed a warm-up session with 10 cases per GUI. No data was collected during the warm-up session. None of the warm-up cases were included in the actual data collection phase.

The observers were randomly assigned the order of the three collection protocols using a counterbalanced design. For each protocol all six observers were shown the exact same cases in the same presentation order. For each radiologist data collection was done within the same day with at least a 30-min break (minimum=30 min, maximum=2 hours) between each protocol. The reading sessions took place in a clinical Radiology reading room with typical lighting conditions. All GUIs recorded the time the observers spent for reading each case.

### User Modeling

The collected data were used to develop individualized user models for predicting a radiologist's perceptual judgments. The purpose of this modeling experiment was to determine which data collection method enables constructing more accurate user models of personal visual judgments.

The predictive models used image features extracted from the mass ROIs. Six textural features were calculated for each ROI: 2 first-order statistical features (entropy, standard deviation) and 4 second-order Haralick features (contrast, correlation, energy, homogeneity). Texture analysis was done using the MATLAB Image Processing Toolbox (The MathWorks, Inc., Natick, Mass.) and standard image processing functions available in the toolbox. These textural features served as inputs to machine learning algorithms for predicting observers' individualized perceptual opinions. The algorithms were implemented in the WEKA environment (University of Waikato, New Zealand), which offers a range of diverse machine learning algorithms. Specifically, the study explored 14 classifiers with default WEKA options: naïve Bayes, discriminative multinomial naïve Bayes, logistic regression, Bayesian neural network, multilayer perceptron, radial basis function network, support vector classifier, adaboost, bagging, random forest, rotation forest, CART, PART, and decision stump. Details on the machine learning algorithms and specific implementation can be found in the WEKA manual.

If the user modeling task was narrowed to a single classifier (e.g., neural network), such approach does not consider the possibility that in personalized user modeling different classifiers may be better suited to different “observer/data collection method” sets. Exploring 14 very diverse classifiers allowed for such possibility. Still, with multiple classifier choices and relatively small datasets, there can be multiple classifiers with similar predictive accuracy (i.e., not significantly different from one another). For a given observer and data collection method, the classifier with the highest test accuracy was selected as the “best performing” one without imposing any requirements of statistically significant superiority.

### Performance Evaluation

Because the three data collection protocols posed different questions to the study participants, the study defined a common experimental framework upon which the user models were developed and compared. Since preferences and rankings can be derived directly from ratings but not vice versa, only a preference task can serve as the common experimental framework for the comparative study. Therefore, the study employed the triple comparisons question used for the preference data collection method as the common denominator for direct comparison of all user models derived in this study.

First, the study utilized the data collected with the preference method “as-is” to construct individual user models. Each model was trained to predict an observer's opinion regarding which pair of masses among three candidate pairs is the most visually similar. In other words, each predictive model was a classifier with four possible outputs (as mentioned earlier, “no mass pair stands out as most similar” is the fourth choice). Separate models were explored for each observer using the 14 classifiers mentioned in the previous section.

To develop similar models with data collected with the hybrid method, the study first reorganized the collected data to derive triple comparisons questions. Below is a brief description on how the study accomplished this step. First, the study notes that the data collected under the hybrid protocol is composed of 20 sets. Each set includes 5 pairwise ratings (Q,A), (Q,B), (Q,C), (Q,D), and (Q,E) where Q is the central, query mass and A, B, C, D, E are the five peripheral masses. It is obvious that any combination of three pairs, e.g., (Q,A), (Q,B), (Q,E) constitutes a triple comparisons question. Therefore, 10 such triplet questions can be generated for each one of the 20 queries for a total of 200 possible questions.

Finally, to derive user models for the triple comparisons question using the data collected with the rating method, the study re-organized the data by creating triplet questions as the study did with the hybrid method. Triplet questions such as, “Which one among the following mass pairs is most similar: (A,B), (A,C), or (A,D)?” were created for which the observers had provided all 3 pairwise rating scores. Through exhaustive combinations, 716 such questions could be formed from the data collected with the rating method.

Under the common experimental framework, user modeling was approached as a classification task with four possible outputs. All user models were evaluated with a leave-one-out train/test sampling scheme. To avoid any unfair bias towards the rating and hybrid data collection methods, the study ensured that there was no overlap between the testing and the training cases. In other words, if (QA,QB,QC) served as a testing case, then the training set excluded cases that contained any of the image pairs (QA,QB), (QA,QC), or (QB,QC) since the user model could learn these pairwise relationships during training, thus biasing heavily testing performance. For all user models, the study used classification accuracy as the performance metric. Standard errors were estimated using bootstrapping with 1000 bootstrap samples. Statistical analysis was performed using the Student's t test for comparisons of differences of user models across observers and data collection methods. The statistical significance of differences between the predictive accuracy of the models was based on the 95% confidence interval.

Since the rating and the hybrid data collection methods used more triple comparisons questions than the preference data (716 vs. 200 vs. 100 for the rating, hybrid, and preference methods respectively), one may believe that the larger sample size gives the two methods an advantage relative to the preference data collection method. To address this issue, the study repeated the experiment using a reduced number of triple comparisons questions for cross-validation. For the ranking method, the study randomly selected 100 out of the 716 triple comparison cases the study had available. For the hybrid method, the study randomly selected 10 queries (which result in 100 triple comparisons cases). To account for sampling error, the study repeated the experiment 5 times and used the corresponding data subset for user modeling with leave-one-out cross-validation, while avoiding the potential train/test overlap discussed earlier.

### Results

Table 1 shows detailed statistics on the amount of time it took each observer to complete the study under all three protocols. The table also includes the average time per case. Please note that the term “case” means something different for each protocol. For the rating method, it is scoring the similarity of a single pair of masses. For the preference method, “case” refers to identifying the most similar pair of masses among 3 possible choices. For the hybrid method, “case” means ranking and rating the similarity of five mass pairs presented simultaneously with respect to a common query image.

With the rating data collection method, on average the experts were significantly slower (13.2±0.23 min) than the residents (7.6±0.5 min) with a P-value <<0.0005. Also with the preference method the experts were slower than the residents (16.7±1.0 min vs. 11.0±3.1 min) but the difference was barely statistically significant (P-value=0.053). Although the study cannot make a similar comparison for the hybrid method due to the prolonged interruption that happened during the hybrid data collection session for Expert 1, the data collection time for the residents was quite variable (average time: 12±3.9 min) and not different from what observed for Expert 2 (13.3±1.5 min). All six observers were significantly faster with the rating method than the preference method (P-values <0.0001). However, there were some inconsistencies as well. Expert 2 and Resident 1 were significantly faster using the hybrid method while Residents 2, 3, and 4 were significantly faster with the preference method. Furthermore, Residents 3 and 4 took roughly twice as long to complete the hybrid data collection task than the rating data collection task while Expert 2 and Resident 2 did not display notable variability among the three methods. No relationship was observed between total time and the order in which an observer executed a data collection protocol.

TABLE 1
Time requirements per data collection protocol.

| DATA | DATA | | | | | | |
|---|---|---|---|---|---|---|---|
| COLLECTION | COLLECTION | | | | | | |
| METHOD | TIME | Expert 1 | Expert 2 | Resident 1 | Resident 2 | Resident 3 | Resident 4 |
| Rating | Total (min) | 13.3 ± 0.7 | 12.9 ± 1.8 | 8.0 ± 0.4 | 7.4 ± 0.6 | 7.0 ± 0.4 | 7.9 ± 0.6 |
| | Per case (sec) | 8.0 ± 4.1 | 7.8 ± 10.3 | 4.8 ± 2.4 | 4.4 ± 3.5 | 4.2 ± 2.2 | 4.8 ± 3.4 |
| Preference | Total (min) | 15.4 ± 1.0 | 14.0 ± 1.1 | 15.4 ± 0.8 | 8.0 ± 0.4 | 11.1 ± 0.7 | 9.7 ± 0.5 |
| | Per case (sec) | 9.2 ± 5.8 | 8.4 ± 7.1 | 9.2 ± 5.4 | 4.8 ± 2.4 | 6.7 ± 4.0 | 5.8 ± 3.3 |
| Hybrid | Total (min) | *** | 13.3 ± 1.5 | 8.3 ± 0.5 | 9.4 ± 0.5 | 13.6 ± 1.2 | 16.8 ± 1.0 |
| | Per case (sec) | 41.2 ± 11.4 | 40.0 ± 22.3 | 24.9 ± 7.2 | 28.2 ± 7.2 | 40.7 ± 16.4 | 50.4 ± 12.8 |

*** Due to a prolonged, unexpected interruption during the reading session, total reading time is not reported for Expert 1. The reading time per case was estimated by excluding the case during which the interruption occurred.

The average Pearson's correlation coefficient between all possible pairs of observers was 0.55 for the rating method and 0.54 for the hybrid method. Experts and residents showed remarkably similar correlations with the rating method (0.55 for experts vs. 0.56 for residents) but less agreement with the hybrid method (0.48 for experts vs. 0.58 for residents). The average Spearman's rank ordered correlation coefficient between all possible pairs of observers for the rankings data collected with the hybrid method was 0.48. The residents showed more agreement than the experts (0.51 vs. 0.43). Experts were in more agreement for pairwise comparisons of masses with similar diagnosis than the residents when using the rating method. Specifically, the Pearson's correlation coefficient between the two experts was 0.62 vs. 0.53 for the residents for mass pairs in which both masses were malignant or benign. In contrast, the residents were in more agreement when rating mass pairs with different diagnoses using the hybrid method. Specifically, the average Pearson's correlation coefficient for all possible pairs of residents was 0.63 when scoring (benign, malignant) mass pairs with the hybrid method while for the experts the correlation was only 0.46 for the same image pairs. Finally, based on the preference data collection method, the average agreement among all possible pairs of observers was 46% (43% for experts vs. 54% for residents).

Table 2 summarizes the classification accuracy of the derived user models for each data collection method respectively.

TABLE 2
Classification accuracy of individualized user models predicting
observers' preference opinions from data collected with the
three methods respectively. Accuracy percentage is reported
for the best performing classifier (listed in parentheses).

| | | PREFERENCE | HYBRID |
|---|---|---|---|
| OBSERVER | RATING METHOD | METHOD | METHOD |
| Expert 1 | 42.5% ± 1.8% | 32% ± 4.6% | 54% ± 3.4% |
| | (Random Forest) | (Bagging) | (Random Forest) |
| Expert 2 | 45.1% ± 1.8% | 47% ± 5.0% | 58% ± 3.5% |
| | (Random Forest) | (SVM) | (Bagging) |
| Resident 1 | 44.7% ± 1.9% | 41% ± 4.7% | 55% ± 3.6% |
| | (Bagging) | (Adaboost) | (SVM) |
| Resident 2 | 43.7% ± 1.9% | 41% ± 4.9% | 56% ± 3.8% |
| | (Random Forest) | (Random Forest) | (Random Forest) |
| Resident 3 | 52.2% ± 1.9% | 40% ± 4.2% | 54% ± 3.3% |
| | (Random Forest) | (PART) | (Random Forest) |
| Resident 4 | 43.7% ± 1.9% | 44% ± 5.2% | 56% ± 3.4% |
| | (Rotation Forest) | (Bayesian Net) | (Bagging) |

All models showed predictive accuracy statistically significantly higher than chance behavior (25% accuracy for random guessing among four possible choices) with two-tailed P-values <0.0001. The classification accuracy of the six user models constructed with the preference data collection method varied between 32% and 47% (average of 40.8%±5%). The user models constructed with the rating data achieved predictive accuracy ranging from 42.5% to 52.2% (average of 45.3%±3.5%). Although these user models were on average better than the preference data user models, the difference was not statistically significant (P-value=0.1079). The user models constructed with the hybrid data had predictive accuracy ranging from 54% to 58% among the six observers (average accuracy of 55.5%±1.5%) which was significantly higher than the accuracy of the user models derived with the rating method (P-value=0.008) and the preference method (P-value=0.0002).

This advantage was consistent with the reduced datasets as well as shown in Table 3. The average classification accuracy of the user models derived with the hybrid data was 49.2±3.2%, which is still statistically significantly better than the accuracy of the user models derived with data collected using either one of the other two methods (P-values <0.008). The user models derived with the preference and rating data had comparable accuracy (P-value 0.058).

TABLE 3
Classification accuracy of individualized user models derived with the
same amount of data for all three data collection methods.
Accuracy percentage is reported for the best performing classifiers.

| | | PREFERENCE | |
|---|---|---|---|
| OBSERVER | RATING METHOD | METHOD | HYBRID METHOD |
| Expert 1 | 34.6% ± 4.7% | 32% ± 4.6% | 45.8% ± 5.0% |
| Expert 2 | 34.8% ± 4.8% | 47% ± 5.0% | 48.7% ± 4.9% |
| Resident 1 | 36.0% ± 4.8% | 41% ± 4.7% | 46.4% ± 4.9% |
| Resident 2 | 36.3% ± 4.7% | 41% ± 4.9% | 53.5% ± 4.9% |
| Resident 3 | 38.0% ± 4.8% | 40% ± 4.2% | 48.0% ± 5.0% |
| Resident 4 | 35.2% ± 4.7% | 44% ± 5.2% | 52.7% ± 4.9% |

### Discussion

This study evaluated individualized modeling of human perceptual similarity opinions for mammographic masses based on data acquired from six observers using three different data collection methods respectively. The aim of the study was to gain useful insights regarding the impact of the data collection method on model accuracy. Through empirical experimentation and several cross-validation scenarios the study determined that machine learning classifiers were capable of modeling user behaviors with accuracy significantly than pure random guess. The hybrid method combining pairwise rating with auxiliary ranking feedback was the most effective way to collect data for modeling radiologists' perceptual preferences compared to two other conventional methods, one based on preferential ranking and the other based on rating. In fact, the study showed significantly higher predictive accuracy for user models derived with such data rather than by collecting preference opinions or ratings only. A smaller advantage was observed when the data collected with the rating method were re-purposed for modeling preference opinions. Further analysis showed that the study could obtain excellent user models using a substantially smaller number of hybrid rating and ranking opinions than by collecting preference opinions only from observers. Overall, the hybrid data collection protocol offers a more comprehensive way for modeling user perceptual opinions than the other conventional methods examined in this study.

In terms of inter-observer agreement, the average correlation coefficient between pairs of radiologists was 0.55 for scoring the visual similarity of two masses in the study. This finding is consistent with that reported earlier by Muramatsu et al who observed average correlation of 0.53 for the same task. It is noteworthy that the personalized user models developed with the hybrid data had lower inter-observer variability than those developed with the rating and preference data. This finding suggests that hybrid data allow the technology to model individuals with better consistency, at least for the image features considered in this study.

The study also address an important aspect of the experiments related to the “multiple comparisons” framework. In the study's current cross-validation setup, the pairwise preference questions generated from the hybrid and the rating methods include questions which share the same first image, e.g., (Q,A,B,C), (Q,A,C,D), (Q,B,C,D) where Q is a central query image used for the hybrid data collection method. For a general CBIR application, the chance of applying an image similarity predictor to answer preference questions that involve the same query image is generally low. However, such application context is indeed very common in the clinical domain and in particular for CBIR applications with relevance feedback. In the latter circumstance, the CBIR system retrieves a few similar images. Then the end user manually provides his/her personal opinions regarding the quality of retrieval results. The solicited user feedbacks are then used to further improve and customize the CBIR model. In this scenario, retrieval samples involved in both the interactive user feedback phase and the automatic retrieval phase do refer to the same query image. Given the important role that relevance feedback techniques play in CBIR and will increasingly play in clinical CBIR, it is believed that the measured performance advantage of the hybrid method is highly relevant and meaningful for practical applications.

In conclusion, collecting perceptual judgments is important for the development of reliable image similarity metrics and clinically useful CBIR systems. The study showed that a hybrid method that involves absolute pairwise scoring with group ranking feedback is an intuitive and efficient way for collecting subjective similarity judgments to model human perceptual opinions with a higher accuracy than other more commonly used data collection methods.

### FIGURES

FIG. 1A: The 40 masses selected for the study. The masses are shown in random order.

FIG. 2A: Screenshot of the iPad GUI developed for the rating method. Zoomed-in viewing of a mass pair is allowed before the user reports his opinion by scrolling the scoring bar. After a user makes an initial score, he can also review the zoomed-in viewing and adjust the score.

FIG. 3A: Screenshot of the iPad GUI developed for the preference method. Zoomed-in viewing of a mass pair is allowed before and after the user reports his opinion by selecting one of the four options.

FIG. 4A: Screenshot of the iPad GUI developed for the hybrid method. For scoring, the user must tap on the radial line connecting the query/central mass and a periphery mass. The line connection changes color to emphasize the mass pair that the user is expected to evaluate. By tapping on a peripheral mass, the user may have zoomed-in viewing of the specific mass pair (i.e., the central and the selected peripheral mass).

What is claimed is:

1. A system comprising a processor and a memory accessible to the processor comprising:
a logic stored in a memory and executable by the processor for rendering a graphical user interface within a first page on an electronic display comprising a plurality of active areas radially linking each of a plurality of peripheral image objects positioned about a curved path about a central image object, the active areas comprising impression characteristic objects hyperlinked to a second page comprising a selected peripheral image object, the central image object, and a user tunable color mapping model; and
a database that stores evaluation data representing the similarity of each of the plurality of peripheral image objects to the central image object established by the user;
where a user's positional movements of a positional object rendered on the second page enables the user to visually rate and represent the similarities between each of the plurality of peripheral image objects to the central image object through the user's selection of impression characteristic objects that renders a spatial separation.

2. The system of claim 1 where each of the plurality of peripheral image objects is rendered in separate graphical interface windows in a windowing environment that are each framed by the impression characteristic objects.

3. The system of claim 2 where the impression characteristic objects are determined by the color mapping model.

4. The system of claim 3 where the color mapping model comprises an RGB model.

5. The system of claim 4 where the positional object comprises a slider rendered on the second page associated with the RGB model comprising a continuum of color associated with a rating associated with a degree of similarity and a hue.

6. The system of claim 5 where the plurality of active areas is actuated by an absolute pointing device and a relative pointing device.

7. The system of claim 1 where the spatial separation is rendered through a visual heuristic object that underlays the central image object rendered on the electronic display.

8. The system of claim 7 where the visual heuristic object intersects a portion of the impression characteristic objects represented as radial lines rendered on the electronic display linking each of the plurality of peripheral image objects to the central image object.

9. The system of claim 8 where the shape of the visual heuristic object automatically adjusts to reflect the relative similarity of each of the peripheral image objects to the central image object.

10. The system of claim 1 where the plurality of peripheral image objects is positioned about a plurality of different radial orbital positions spaced about the central image object on the electronic display.

11. The system of claim 10 where each of the radial links is represented as a radial line rendered on the electronic display showing a separate dimension of the peripheral image objects.

12. The system of claim 1 where actuation of the hyperlink renders a second Web page comprising a magnified view of the selected peripheral image object, the central image object, and a user controllable visual feedback.

13. The system of claim 1 further comprising a mobile translator that generates the code that renders Web pages that display a perceptual opinion capturing and modeling system interface to account for the screen size and architecture of the mobile device.

14. A human perceptual opinion capturing and modeling system comprising:
a non-transitory logic stored in a memory and executable by a mobile processor for rendering a graphical user interface within a Web page on an electronic mobile display comprising a plurality of active areas radially linking a plurality of peripheral image objects positioned around an orbital path about a central image object on the electronic mobile display, the active areas comprising impression characteristic objects and hyperlinks that render a second Web page comprising a user selected peripheral image object, the central image object, and a visual feedback mechanism; and
a database that stores evaluation data representing a user's visual comparison of each of the plurality of peripheral image objects to the central image object;
where a user's positional movements of a positional object rendered on the electronic mobile display enable the user to visually rate and represent the similarities between each of the plurality of peripheral image objects to the central image object through impression characteristic objects and a discernible spatial separation.

15. The system of claim 14 where each of the plurality of peripheral image objects is rendered in separate graphical interface windows that are each framed by the impression characteristic objects.

16. The system of claim 14 where the impression characteristic objects are determined by the visual feedback model.

17. The system of claim 16 where the positional object comprises a slider rendered on the second Web page associated with the RGB model comprising a continuum of color associated with a comparison rating.

18. The system of claim 17 where the plurality of active areas is actuated by an absolute pointing device and a relative pointing device.

19. The system of claim 14 where the spatial separation is rendered through a visual heuristic object that underlays the central image object with the plurality of peripheral image objects.

20. The system of claim 19 where the visual heuristic object intersects a portion of the impression characteristic objects linking each of the plurality of peripheral image objects to the central image object.
